(19) United States
(12) Patent Application Publication
(10) Pub. No.: US 2002/0148774 A1
(43) Pub. Date: Oct. 17, 2002

(54) Asymmetric hydrophilic membrane by grafting

(76) Inventors: I-fan Wang, San Diego, CA (US); Maria A. Calfy, Chula Vista, CA (US); Sonia M. McClendon, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/777,608

(22) Filed: Feb. 6, 2001

(51) Int. Cl. B01D 71/00

(52) U.S. Cl. 210/490; 210/500.29; 210/500.36; 210/500.41

(57) ABSTRACT

Asymmetric hydrophilic polymeric membranes are disclosed wherein the asymmetry between the pore diameters of the first and second membrane faces is at least about 2:1, and wherein the membrane comprises a hydrophobic polymer to which hydrophilic moieties have been covalently bonded. A method of preparing such membranes is provided, wherein an asymmetric hydrophobic polymeric membrane is immersed in a solution comprising a solvent, a free radical polymerization initiator, and a monomer having hydrophilic moieties, then exposed to an energy source, whereby the monomer is covalently bonded to the hydrophobic polymer of the membrane. A method of rendering a hydrophobic polymeric substrate permanently hydrophilic is disclosed, wherein a hydrophobic polymeric substrate is immersed in a solution of monomer and free radical polymerization initiator in an alkylene glycol solvent, then exposed to an energy source so as to covalently bond the hydrophilic monomer to the substrate.

### FIELD OF THE INVENTION

The present invention relates to asymmetric hydrophilic polymeric membranes wherein the membrane comprises a hydrophobic polymer to which hydrophilic moieties have been covalently bonded. A method of preparing such membranes by grafting hydrophilic monomers to the hydrophobic polymer of the membrane is also provided.

### BACKGROUND OF THE INVENTION

Hydrophilic asymmetric microfiltration and ultrafiltration membranes are useful in many applications. For example, such membranes may be used for a variety of filtration applications, such as purification and testing applications in the food and beverage industry, pharmaceutical, medical laboratories, battery separators, ultrapure water for the electronics industry, or water for injection (WFI). The membranes may be used in a variety of forms, such as, for example, disks, cartridges and the like. The asymmetric membranes have a large pore side and a microporous or ultraporous surface. Through applying a solids-containing liquid sample to the large pore surface, a liquid, largely free of solids, emerges from the microporous surface.

Such membranes typically start out as hydrophobic membranes. Water will not generally pass through them under routine operating conditions. Therefore, in applications requiring operation of the membranes in aqueous environments, the membranes, or the polymers prior to fabrication into membranes, are typically reacted with, or mixed with, respectively, moieties that cause the resulting membranes to become hydrophilic. Several different processes and reagents have been utilized to cause initially hydrophilic membranes to become hydrophilic. These include surface treatments of finished membranes, inclusion of hydrophilic components in the membrane casting solution, sulfonating hydrophobic polymers prior to casting them as membranes, cross-linking hydrophilic moieties throughout the membrane, and the like.

Each of these methods for imparting hydrophilicity to membranes may have inherent problems. For example, where a membrane is post-treated with a moiety to impart hydrophilicity there is a potential that the moiety will leach and contaminate the sample. One may attempt to minimize leaching through coating the membrane with a cross-linked polymer. Steuck, in U.S. Pat. No. 4,618,533, discloses a composite porous polyvinylidene fluoride membrane that is directly coated with a polymer formed of a cross-linked hydroxyalkyl acrylate. Other examples of the use of cross-linking or grafting to prepare hydrophilic membranes are disclosed in U.S. Pat. No. 5,019,260 to Gsell et al.; EP-561277-B1 to Scarmoutzos; U.S. Pat. No. 5,318,866 to Degen et al.; U.S. Pat. No. 5,215,692 to Hörl et al.; U.S. Pat. No. 6,614,309 to Chung et al.; U.S. Pat. No. 4,845,132 to Masuoka et al.; U.S. Pat. No. 5,476,590 to Brose et al.; U.S. Pat. No. 3,839,172 to Chapiro et al.; U.S. Pat. No. 5,310,809 to Pabon et al.; U.S. Pat. No. 4,506,035 to Barnett et al.; U.S. Pat. No. 4,605,685 to Momose et al.; U.S. Pat. No. 4,407,846 to Machi et al.; U.S. Pat. No. 5,180,788 to Vroomans; and U.S. Pat. No. 4,280,970 to Kesting.

### SUMMARY OF THE INVENTION

The present invention provides membranes and methods for preparing membranes consisting of asymmetric microfiltration and ultrafiltration membranes with permanent hydrophilic groups covalently bonded to the membrane by visible light, ultraviolet (UV), thermal, or irradiation grafting. The membranes are internally hydrophilic and non-leachable, and may be used in ultrapure water, water for injection (WFI), or pharmaceutical applications. The method imparts permanent hydrophilicity to the membrane, as well as high water flow and good integrity.

In a first embodiment of the present invention, a polymeric membrane is provided, the membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure include a network of structural surfaces capable of contacting a filter stream, and wherein the membrane includes a hydrophobic base polymer and a plurality of hydrophilic moieties covalently bonded to the hydrophobic base polymer at the structural surfaces.

In various aspects of the first embodiment, the asymmetry between the average pore diameters of the first porous face and the second porous face is at least about 5:1, at least about 10:1, at least about 20:1, or at least about 200:1.

In a further aspect of the first embodiment, the supporting structure includes an isotropic region adjacent the second porous face, the isotropic region having substantially constant pore size, the supporting structure further including an asymmetric region adjacent the isotropic region. The asymmetric region may extend through at least about 50% of the supporting structure but not more than about 85% of the supporting structure.

In another aspect of the first embodiment, the hydrophobic polymeric membrane includes polyvinylidene fluoride. The hydrophobic polymeric membrane may also include polysulfone, polyarylsulfone, polyethersulfone, polyolefin such as polyethylene or polypropylene, polyvinyl chloride, polyacrylonitrile, polytetrafluoroethylene, poly(tetrafluoroethylene-co-ethylene), cellulose, polyester or nylon.

In yet another aspect of the first embodiment, the hydrophobic polymer of the hydrophobic polymeric membrane has a surface tension greater than or equal to about 18 dynes/cm, more preferably greater than or equal to about 25 dynes/cm.

In a further aspect of the first embodiment, the hydrophilic moiety is selected from the group consisting of hydroxyl groups and carboxylic acid groups, or may be derived from a monomer including acrylic acid, hydroxyethylmethacrylate, or vinylpyrrolidone.

In a second embodiment of the present invention, a method of preparing a highly asymmetric hydrophilic polymeric membrane is provided including the steps of: providing an asymmetric hydrophobic polymeric membrane including a hydrophobic polymer and having a first porous face having a first average pore diameter, a second porous face having a second average pore diameter, and a porous supporting structure therebetween, the first and second average pore diameters having an asymmetry of at least about 2:1; preparing a monomer solution including a solvent and a monomer having a hydrophilic moiety, the monomer being capable of covalently bonding to the hydrophobic polymer; contacting the membrane with the monomer solution; and exposing the membrane to an energy source such that the monomer is covalently bonded to the polymer of the membrane by a polymerization reaction.

In one aspect of the second embodiment, the hydrophobic polymer includes polyvinylidene fluoride. The monomer includes acrylic acid, hydroxyethylmethacrylate, or vinylpyrrolidone.

In a further aspect of the second embodiment, the solution contains from about 1 to about 30 wt. % monomer, more preferably from about 5 to about 10 wt. % monomer.

In another aspect of the second embodiment, the monomer solution includes a free radical polymerization initiator and wherein the polymerization reaction is a free radical polymerization reaction. The free radical polymerization initiator includes sodium persulfate or 2-hydroxy-2-methyl-1-phenyl-1-propan-1-one. The solution contains from about 0.05 to about 3 wt. % free radical polymerization initiator, more preferably from about 0.1 to about 1 wt. % free radical polymerization initiator.

In yet another aspect of the second embodiment, the solvent includes an alcohol. The alcohol includes isopropanol, t-amyl alcohol, 1-butanol, 2-butanol, ethanol, and mixtures thereof, or includes a mixture of an alcohol and water. The alcohol in the mixture of alcohol and water includes isopropanol. The solvent may also include ethylene glycol.

In a further aspect of the second embodiment, the method includes the step of presoaking the membrane in an alkaline solution having a pH of about 9, wherein the presoaking is conducted before the contacting step. The method may also include the step of rinsing the membrane in a liquid, wherein the step of rinsing the membrane in a liquid is conducted after the step of presoaking the membrane and before the contacting step. The liquid includes water or an alcohol.

In a further aspect of the second embodiment, the method includes the step of removing the membrane from the monomer solution, wherein the step is conducted after the contacting step and before the exposing step. The method may further include the step of rinsing the membrane with a liquid, or may further include the step of drying the membrane at an elevated temperature.

In another aspect of the second embodiment, the energy source includes ultraviolet light. The energy source may also include visible light and thermal radiation.

In a further aspect of the second embodiment, the step of exposing the membrane to an energy source includes exposing the membrane to an ultraviolet radiation on the second porous face. The step of exposing the membrane to an energy source may be conducted under inert atmosphere.

In a third embodiment of the present invention, a method of rendering a hydrophobic polymeric substrate permanently hydrophilic is provided, the method including the steps of: preparing a monomer solution including an alkylene glycol solvent, and a monomer having a hydrophilic moiety; contacting a hydrophobic polymeric substrate with the monomer solution; and exposing the substrate to an energy source such that the monomer is covalently bonded to the polymer of the substrate by a polymerization reaction.

In an aspect of the third embodiment, the alkylene glycol solvent includes ethylene glycol. The substrate includes a membrane, such as an isotropic membrane, an anisotropic membrane, or an asymmetric membrane. The asymmetric membrane may have a first porous face having a first average pore diameter, a second porous face having a second average pore diameter, and a porous supporting structure therebetween, the first and second average pore diameters having an asymmetry of at least about 2:1.

In a further aspect of the third embodiment, the substrate includes a melt-blown material. The substrate includes woven material, nonwoven material, and web. The hydrophobic polymer includes polyvinylidene fluoride.

In yet another aspect of the third embodiment, the solution contains from about 1 to about 30 wt. % monomer, preferably from about 5 to about 10 wt. % monomer. The monomer solution includes a free radical polymerization initiator and wherein the polymerization reaction is a free radical polymerization reaction. The solution contains from about 0.05 to about 3 wt. % free radical polymerization initiator, more preferably from about 0.1 to about 1.0 wt. % free radical polymerization initiator.

In a further aspect of the third embodiment, when the hydrophobic polymer includes polyvinylidene fluoride, the method further includes the step of presoaking the hydrophobic membrane in an alkaline solution having a pH of about 9 or higher to produce a presoaked membrane, wherein the step is conducted before the contacting step. The method may further include the step of rinsing the presoaked membrane in a liquid, wherein the step is conducted before the contacting step.

In a fourth aspect of the present invention, a battery separator is provided including an asymmetric hydrophilic polymeric membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure include a network of structural surfaces, and wherein the membrane includes a hydrophobic base polymer and a plurality of hydrophilic moieties covalently bonded to the hydrophobic base polymer at the structural surfaces.

In further aspects of the fourth embodiment, the asymmetry between the average pore diameters of the first porous face and the second porous face is at least about 5:1, at least about 10:1, at least about 20:1, or at least about 200:1.

In other aspects of the fourth embodiment, the hydrophobic polymeric membrane includes polyvinylidene fluoride. The hydrophobic polymeric membrane may also include polysulfone, polyarylsulfone, polyethersulfone, polyolefin such as polyethylene or polypropylene, polyvinyl chloride, polyacrylonitrile, polytetrafluoroethylene, poly(tetrafluoroethylene-co-ethylene), cellulose, polyester or nylon.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

The prior art does not disclose asymmetric membranes prepared from hydrophobic polymers that have been rendered hydrophilic by grafting a monomer containing hydrophilic moieties, such as vinylpyrrolidone, onto the surfaces of the membrane. Accordingly, it would be desirable to provide an asymmetric, hydrophilic, polymer membrane having a high degree of water permeability, sufficient strength and rigidity, that operates efficiently in separations and testing applications, and which may be produced from a simplified grafting process.

Introduction

Chemical grafting is the process of attaching a low molecular weight active group to a parent polymer, for example, a polysulfone or polyvinylidenedifluoride (PVDF), so as to modify the surface of the polymer. In one embodiment of such a chemical grafting process, a polymer membrane is immersed in a solution of ethylene glycol (EG) containing one or more monomers, for example, vinylpyrrolidone or acrylate, and polymerization initiators. The membrane is then post-treated with UV radiation to induce grafting. In this way, permanent hydrophilic groups may be covalently bonded to a membrane.

The Hydrophobic Polymeric Membrane

Membranes that are suitable for grafting in accordance with the present invention consist of asymmetric hydrophobic membranes. The term “asymmetric” as used herein relates to a membrane possessing a pore size gradient. That is, asymmetric membranes possess their smallest or finest pores in or adjacent to one surface of the membrane, generally referred to as the “skin” surface or “shiny” side of the membrane. The increase in pore size between the skin surface and the opposite surface of the membrane is generally gradual, with the smallest pore size nearest the skin surface and the largest pores being found at or adjacent to the opposite, coarse-pored surface, generally referred to as the “open” surface or the “dull” side of the membrane. Another variety of asymmetric membrane, commonly described as having a “funnel-with-a-neck” structure, includes both an asymmetric region and an isotropic region, the isotropic region having a uniform pore size. The isotropic region typically extends from the skin surface of the membrane through about 5-80% of the thickness of the membrane, more preferably from about 15-50% of the thickness of the membrane.

The membranes of preferred embodiments also have a porous supporting structure between the two sides of the membrane. The nature of the porous supporting structure of a membrane may depend on the composition of the casting dope and the coagulation bath. The supporting structure may include closed cells, open cells of substantially the same pore size from one side of the membrane to the other, open cells with a gradation of pore sizes from one side of the membrane to the other, or finger-type structures, generally referred to as “macrovoids.” Macrovoids typically will vary substantially in size from the surrounding porosity, and generally do not communicate with surface pores. In a preferred embodiment, the porous supporting structure includes a network of structural surfaces capable of contacting a filter stream, defined herein as including any fluid substance, including liquids and gases, that passes through the membrane via the porous supporting structure.

Whether the membrane has an asymmetric or funnel-with-a-neck structure may depend upon several factors involved in the preparation of the membrane, including the type and concentration of the polymer, the solvent, and the nonsolvent; the casting conditions such as the knife gap, and the dope temperature; environmental factors such as the exposure time between casting and quenching, and the humidity of the exposure atmosphere; and the composition and temperature of the quench bath. In various embodiments, the asymmetry in pore size between the skin side and dull side of the membrane may range from about 1:2, 1:5, 1:10, 1:20, 1:50, 1:100, or 1:200 to about 1:1,000 or 1:10,000 or greater, more preferably from 1:2, 1:5, 1:10, or 1:20 to about 1:50, 1:100, 1:200 or 1:1,000.

Membranes that are suitable for grafting in accordance with the present invention include virtually any formed, initially hydrophobic, polymer membrane that has sufficient porosity so as to allow treatment with the monomer-containing solution. Such suitable membranes may typically possess porosities characteristic of ultrafiltration or microfiltration membranes. Membranes within the ultrafiltration range preferably possess molecular weight cutoffs of from about 10,000 Daltons to about 1,000,000 Daltons and may have pore diameters from about 0.001 μm to about 0.050 μm on the skin side of the membrane. Microfiltration membranes typically possess pore diameters of at least about 0.01 or about 0.05 μm to about 5, 8, 10 or 20 μm on the skin side of the membrane.

The hydrophobic membranes that may be grafted may be in any suitable shape or form, including, but not limited to, sheet and hollow fiber cast polymer membranes. Suitable membranes further include both those membranes that are cast from a single polymer solution or dope, referred to as “integral” membranes, as well as non-integral or composite membranes that are cast from more than one polymer solution or dope to form a layered or composite membrane. Composite membranes may also be assembled from two or more fully formed membranes after casting.

Any hydrophobic polymer that may be formed into a membrane by a casting or other process, that possesses the pore size criteria described above and which may be rendered hydrophilic through grafting with a hydrophilic polymer, is generally suitable for use in the present invention. Generally, hydrophilicity is a characteristic of materials exhibiting an affinity for water. Hydrophilic materials readily adsorb water and possess a high surface tension value. In a preferred embodiment, useful hydrophobic polymers may possess a surface tension greater than or equal to about 18 dynes/cm, more preferably greater than or equal to about 25 dynes/cm. Table 1 provides calculated surface tension values for several hydrophobic polymeric materials.

TABLE 1

| | Surface Tension |
|---|---|
| Polymeric Material | (dynes/cm) |
| Teflon | 18 |
| Polyvinylidene fluoride | 25 |
| Polypropylene | 29 |
| Polyethylene | 31 |
| Polyvinyl chloride | 39 |
| Polysulfone | 41 |
| Polyacrylonitrile | 44 |
| Cellulose | 44 |
| Nylon 6/6 | 46 |

Preferred chemistries for the hydrophobic polymers include sulfone polymers, such as polysulfone, polyarylsulfone, and polyethersulfone, fluorinated polymers, such as polyvinylidene difluoride (PVDF), polypropylene, polyethylene, polyethylene-polyvinyl chloride, polyacrylonitrile, cellulose, polyester, nylon, polytetrafluoroethylene (PTFE or Teflon™), and mixtures or combinations thereof. Preferred membranes include the highly asymmetric PVDF membranes disclosed in U.S. Pat. No. 5,834,107 (incorporated herein by reference in its entirety) and the highly asymmetric polyethersulfone membranes disclosed in U.S. Pat. No. 5,886,059 (incorporated herein by reference in its entirety).

In one preferred embodiment, the hydrophobic membranes subjected to grafting are made from polyethersulfone (PES) and have highly asymmetric regions of gradually increasing pore diameters. On one side of the PES membrane is a skin face having relatively small diameter pores while the opposite or dull face of the membrane has relatively large diameter pores. The difference in porosity between the skin face and the opposite face is typically between about 1:2 and about 1:10,000. The difference in porosity between the skin face and the opposite face is preferably between about 1:5 and about 1:10,000. More preferably, the difference in porosity is between about 1:10 and about 1:20, 1:50, 1:100, or 1:200. In addition, membranes made by methods disclosed herein have a gradual slope of pore size from the skin face to the opposite face. Thus, during filtration, larger particles may enter the membrane through the larger pores, but do not exit through the smaller pores. Because the larger particles do become lodged at the outer surface, the membranes made by the methods disclosed herein are not easily clogged with large particles.

In another preferred embodiment, the hydrophobic membrane is a microporous PVDF polymer membrane having a microporous surface with minimum pores, and an opposite surface with maximum pores. Such membranes may be prepared from PVDF HYLAR-461, (available from Ausimont USA, Inc. of Thorofare, N.J.) and may also contain from about 1 wt. % to about 30 wt. % of polyvinylpyrrolidone (PVP), of which a preferred type is a PVP with an average molecular weight of about 45,000 Daltons. Alternatively, the membrane may contain PVP having an average molecular weight of about 900,000 Daltons. Such membranes may preferably have supporting materials laminated to them, such as, for example, a nonwoven polymer fabric. Such membranes may preferably be in the form of a planar sheet or a hollow fiber.

Hydrophilic membranes may also be grafted according to the present invention. Such hydrophilic membranes include hydrophobic membranes that have been post-treated with a surfactant or other material capable of rendering the membrane hydrophilic, as well as membranes prepared from a casting dope containing a hydrophilic material in addition to a hydrophobic polymer. In membranes rendered hydrophilic according to such methods, the hydrophilic component may be subject to leaching from the membrane, resulting in a decrease in hydrophilicity of the membrane with use. By grafting a hydrophilic monomer to such membranes, substantial non-leachability and substantially permanent hydrophilicity may be imparted to the membrane.

The Hydrophilic Monomer

The membranes of a preferred embodiment are initially hydrophobic and are rendered hydrophilic through grafting a hydrophilic monomer to the hydrophobic polymer such that a covalent bond is formed. More than one hydrophilic monomer may be employed simultaneously. The hydrophilic monomer as used herein has the ability to cause a surface to have increased wettability by water. The wetting of solid surfaces by liquids is an important process for many industrial applications. Wetting, by definition, is the process of one fluid displacing another fluid at a solid surface. However, in most cases, the term is used to describe the displacement of air by a liquid, or the ability of the membrane to imbibe water.

Suitable hydrophilic monomers may contain hydrophilic chemical functional groups such as hydroxyl groups, carboxylic acid groups and the like. In a preferred embodiment, monomers include acrylic acid, hydroxyethylmethacrylate, and vinylpyrrolidone, with vinylpyrrolidone being particularly preferred.

The hydrophilic monomer may be applied to the hydrophobic membrane in the form of a solution. Suitable solvents include alcohols, such as isopropanol, t-amyl alcohol, 1-butanol and 2-butanol and mixtures thereof, either alone or admixed with water. If an alcohol in pure form is used as a solvent, the membrane may optionally be pre-wet with water so as to facilitate wetting of the membrane by the solution. In a preferred embodiment, mixtures of isopropanol and water are used. Since the monomers are readily soluble at room temperature, special solution preparation procedures, such as dissolving at elevated temperature, are not required.

In a particularly preferred embodiment, the solvent is ethylene glycol. Grafted membranes prepared using a solution of hydrophilic monomer in ethylene glycol are generally less brittle than those prepared using a solution of isopropyl alcohol and water. Ethylene glycol solvent is suitable for use not only in the preparation of asymmetric hydrophilic polymeric membranes as described above, but also in the preparation of symmetric membranes, including isotropic and anisotropic membranes prepared by casting techniques, as well as webs, nonwovens, or wovens prepared, for example, using melt-blown technology, such as melt-blown polyethylene or polypropylene. Such hydrophilic melt-blown membranes are particularly well suited for use in battery separator applications.

Preferably, the monomer solution contains from about 1 to about 30 wt. % monomer, more preferably from about 5 to about 10 wt. % of the monomer. For membranes having a larger pore size, concentrations at the higher end of the range are used. Conversely, for membranes with a smaller pore size, it is desirable to use concentrations at the lower end of the range. At higher concentrations outside of the preferred ranges, the solution may block the membrane's pores, resulting in a drop in the flow rate of the membrane. At lower concentrations outside of the preferred range, insufficient grafting occurs. In either case, the hydrophilicity of the resulting membrane will be lower than that of a membrane prepared from a solution in the preferred range.

The solution also contains one or more free radical polymerization initiator. Suitable initiators include sodium persulfate and 2-hydroxy-2-methyl-1-phenyl-1-propane-1-one. Preferably, a mixture of sodium persulfate and 2-hydroxy-2-methyl-1-phenyl-1-propane-1-one is used. The concentration of the initiator in the solution will range from about 0.05 to about 3 wt. %, more preferably from about 0.1 to about 1.0 wt. %. Generally, as the concentration of initiator in solution increases, the grafted chains become shorter and more branching occurs.

The Grafting Process

The grafting process involves immersing the membrane in the monomer solution or otherwise contacting the membrane with the monomer solution and allowing the monomer solution to substantially penetrate the pores of the membrane. An immersion time of from about 10 seconds to about 10 minutes is usually sufficient to allow the monomer solution to saturate the membrane. Typically, an immersion time of from about 10 seconds to about 1 minute is used. More typically, an immersion time of from about 30 seconds to one minute is used.

When the membrane includes PVDF, a difficult polymer to graft, an alkaline treatment is conducted prior to immersing the membrane in the monomer solution. The alkaline solution preferably has a pH of about 9 or higher. The alkaline treatment forms active sites in the membrane at which grafting may occur. Although PVDF tends to degrade upon exposure to high pH solutions, no noticeable effect on physical properties of the membrane, such as tensile strength, were observed after treatment. After the alkaline treatment, the membrane is rinsed in deionized water to remove residual alkalinity.

The membrane is then removed from solution and exposed to an energy source to induce grafting of the monomer to the polymer of the membrane. Suitable grafting energy sources include visible light, thermal radiation (heat), ultraviolet (UV) radiation, or any other radiation capable of inducing grafting. Preferably, UV radiation is used because it is more effective in inducing grafting, especially for the more hydrophobic polymers, for example PVDF, which tend to be more difficult to graft. If a hydrophobic polymer is used that tends to graft easily, then other forms of radiation, for example, thermal radiation or visible light, may be used. When UV radiation is used, irradiation times ranging from about 10 seconds to up to about 10 minutes are used. More typically, the irradiation time will range from about 10 seconds to about 1 minute. The irradiation time depends upon the surface energy of the polymer. Generally, the more hydrophobic the polymer, the more UV irradiation time is required. Preferably the wavelength of the UV radiation will be about 254 nm.

In a preferred embodiment, the monomer solution contains a free radical polymerization initiator and the polymerization reaction initiated by the irradiation is a free radical polymerization reaction. However, depending upon the choice of monomer and the irradiating energy, the monomer moieties may be bonded to the surfaces of the membrane without including a free radical polymerization initiator in the monomer solution.

The irradiation is conducted in an inert atmosphere, such as a nitrogen purge, because atmospheric oxygen is an inhibitor for grafting. When UV radiation is used, preferably the skin side of the membrane faces the radiation source so as to provide better UV radiation penetration through the membrane.

After the irradiation is completed, the grafted membrane is preferably rinsed in deionized water, alcohol, or another suitable liquid to remove residual monomer. It is also preferable to dry the grafted membrane at elevated temperature, preferably in an oven at a temperature of about 100-120° C. for about 5 to 10 minutes.

The Grafted Membranes

The hydrophobic membranes rendered hydrophilic by grafting in accordance with the invention preferably possess relatively quick water imbibing times. Imbibing times may be measured by applying a fixed amount of water onto the membrane and recording the time required for the water to be absorbed into the membrane. Thus, grafting of hydrophilic monomer to the hydrophobic membranes in accordance with the present invention results in hydrophilic membranes having imbibing times ranging from instantaneous to about 10 seconds. The hydrophilicity imparted to the membrane in this way is “permanent”, with “permanent” defined as substantially resistant to loss of hydrophilicity through leaching of the covalently bound hydrophilic monomer from the membrane over the course of normal use of the treated membrane. Whether sufficient hydrophilic monomer has been grafted to the surfaces of the membrane may be determined by measuring the water imbibing time.

### EXAMPLES

All membranes used in the following examples were obtained from US Filter of San Diego, Calif. All chemicals were obtained from Aldrich Chemical of Milwaukee, Wis.

### Example 1

A monomer solution containing 0.5 wt. % ferrous sulfate, 1 wt. % triethyleneglycol dimethacrylate (TEGDA), 5 wt. % vinylpyrrolidone (VP), 1 wt. % 2-hydroxy-2-methyl-1-phenyl-propan-1-one, 1 wt. % sodium persulfate, and 91.5 wt. % of isopropanol/water (50/50 by volume) was prepared. Three samples of hydrophobic polysulfone membrane with mean flow pore (MFP) size of 0.45 μm (BTS-25) were immersed in the solution for 30 seconds, then moved to a nitrogen box and exposed to ultraviolet (UV) light at 365 nm for one, two and three minutes, respectively. The resulting membranes were rinsed with deionized (DI) water for ten minutes, then oven-dried at 120° C. for 5 minutes.

The wettability, water flow rate, and MFP size were determined by testing each of the treated membranes after repeated wet and dry cycles. The test results, provided in Table 2, show that UV exposure time has no substantial effect on MFP size or wettability.

TABLE 2

| UV Exposure | Water Flow (ml/min) | MFP Size | |
|---|---|---|---|
| (minutes) | for 47 mm disc at 10 psi | (μm) | Wettability |
| 1 | 750 | 0.42 | Instant Wetting |
| 2 | 800 | 0.42 | Instant Wetting |
| 3 | 876 | 0.42 | Instant Wetting |

### Example 2

A solution containing 0.5 wt. % ferrous sulfate, 1 wt. % TEGDA, 5 wt. % acrylic acid (AA), 1 wt. % 2-hydroxy-2-methyl-1-phenyl-propan-1-one, 1 wt. % sodium persulfate, and 91.5 wt. % of isopropanol/water (50/50 by volume) was prepared. Hydrophobic polysulfone membrane samples (BTS-25, with MFP of 0.45 μm) were immersed in the solution for 30 seconds, then moved to a nitrogen box and subjected to UV light at 365 nm for one to three minutes. The resulting membranes were rinsed with DI water for ten minutes, then oven-dried at 120° C. for 5 minutes. Water flow, MFP, and wettability test results for the grafted membranes were similar to those of the grafted membranes of Example 1.

### Example 3

The effect of solvent chemistry on the properties of treated membranes was investigated by preparing monomer solutions based on ethylene glycol rather than isopropanol/water. A monomer solution containing 0.5 wt. % ferrous sulfate, 1 wt. % TEGDA, 5 wt. % VP, 1 wt. % 2-hydroxy-2-methyl-1-phenyl-propan-1-one, 1 wt. % sodium persulfate, and 91.5 wt. % ethylene glycol was prepared. A polysulfone membrane with a MFP of 0.45 μm, polypropylene (PP) membrane with a MFP of 0.2 μm, and a PVDF membrane with a MFP of 0.45 μm were each immersed in the monomer solution for 30 seconds, then moved to a nitrogen box and exposed to UV light at 365 nm for one to three minutes. The PVDF membrane was pre-soaked in an alkaline solution (pH=14), then rinsed in DI water before immersion in the monomer solution. The resulting membranes were rinsed with DI water for ten minutes, then oven-dried at 120° C. for 5 minutes.

The treated membranes were characterized as in Example 1. The test results, presented in Table 3, show that show that the grafting process has no substantial effect on MFP size.

TABLE 3

| | UV | Water Flow | MFP | |
|---|---|---|---|---|
| Membrane | Exposure | (ml/min) for 47 mm | Size | |
| Type | (minutes) | disc at 10 psi. | (μm) | Wettability |
| Polysulfone | 1 | 857 | 0.42 | Instant Wetting |
| PVDF | 3 | 200 | 0.43 | Instant Wetting |
| PP | 3 | less than 40 | 0.2 | Wetting |

### Example 4

In Example 3, UV light having a wavelength of 365 nm was used. In Example 4, the effect of using a shorter UV wavelength, 254 nm, on the properties of treated membranes was investigated.

A monomer solution containing 0.5 wt. % ferrous sulfate, 1 wt. % TEGDA, 5 wt. % VP, 1 wt. % 2-hydroxy-2-methyl-1-phenyl-propan-1-one, 1 wt. % sodium persulfate, and 91.5 wt. % ethylene glycol was prepared. A polysulfone membrane with a MFP of 0.45 μm, a PP membrane with a MFP of 0.2 μm, and a PVDF membrane with a MFP of 0.45 μm were each immersed in the monomer solution for 30 seconds, then moved to a nitrogen box and exposed to UV light at 254 nm for one to three minutes. The PVDF membrane was pre-soaked in an alkaline solution (pH=14), then rinsed in deionized water before immersion in the monomer solution. The resulting membranes were rinsed with deionized water for ten minutes, then oven-dried at 120° C. for 5 minutes.

The treated membranes were characterized as in Example 1. The resulting membranes are all instantly water-wettable and maintained good water flow rate and integrity after repeated wet and dry cycles, as shown in Table 4.

TABLE 4

| Membrane | UV Exposure | Water Flow (ml/min) for | |
|---|---|---|---|
| Type | (minutes) | 47 mm disc at 10 psi. | Wettability |
| Polysulfone | 1 | 920 | Instant Wetting |
| PVDF | 3 | 260 | Instant Wetting |
| PP | 3 | 86 | Instant Wetting |

### Example 5

The utility of ethylene glycol as a solvent in the preparation of treated melt-blown membrane webs was investigated. A monomer solution containing 0.5 wt. % ferrous sulfate, 1 wt. % TEGDA, 5 wt. % VP, 1 wt. % 2-hydroxy-2-methyl-1-phenyl-propan-1-one, 1 wt. % sodium persulfate, and 91.5 wt. % ethylene glycol was prepared. Hydrophobic melt blown PP samples with a pre-rating MFP size of 0.8 μm, 5 μm, 10 μm, and 30 μm, respectively, were immersed in the solution for 30 seconds, then moved to a nitrogen box and subjected to UV light at 365 nm for three or ten minutes. The resulting melt-blown webs were rinsed with DI water for ten minutes, then oven-dried at 120° C. for 10 minutes.

The MFP size and wettability of the treated membranes were determined. The test results, shown in Table 5, demonstrate that UV exposure times over three minutes do not substantially affect the wettability of the membrane.

TABLE 5

| | UV Exposure | MFP Size | |
|---|---|---|---|
| Membrane Type | (min) | (μm) | Wettability |
| PP meltblown 0.8 μm | 3 | 0.8 | Instant Wetting |
| PP meltblown 5 μm | 3 | 5 | Instant Wetting |
| PP meltblown 10 μm | 3 | 10 | Instant Wetting |
| PP meltblown 30 μm | 3 | 30 | Instant Wetting |
| PP meltblown 0.8 μm | 10 | 0.8 | Instant Wetting |
| PP meltblown 5 μm | 10 | 5 | Instant Wetting |
| PP meltblown 10 μm | 10 | 10 | Instant Wetting |
| PP meltblown 30 μm | 10 | 30 | Instant Wetting |

The permanence of the wettability of the membranes of Table 5 was investigated by subjecting the membranes to a prolonged alkaline treatment. The membranes were immersed in a 50 wt. % KOH solution for fourteen days, rinsed in running deionized water for 10 minutes, then oven-dried. The melt-blown webs subjected to the alkaline treatment remained instantly wettable.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A polymeric membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure comprise a network of structural surfaces capable of contacting a filter stream, and wherein the membrane comprises a hydrophobic base polymer and a plurality of hydrophilic moieties covalently bonded to the hydrophobic base polymer at the structural surfaces.

2. The membrane of claim 1, wherein the asymmetry between the average pore diameters of the first porous face and the second porous face is at least about 5:1.

3. The membrane of claim 2, wherein the asymmetry between the average pore diameters of the first porous face and the second porous face is at least about 10:1.

4. The membrane of claim 3, wherein the asymmetry between the average pore diameters of the first porous face and the second porous face is at least about 20:1.

5. The membrane of claim 4, wherein the asymmetry between the average pore diameters of the first porous face and the second porous face is at least about 200:1.

6. The membrane of claim 1, wherein the supporting structure comprises an isotropic region adjacent the second porous face, the isotropic region having substantially constant pore size, the supporting structure further comprising an asymmetric region adjacent the isotropic region.

7. The membrane of claim 6, wherein the asymmetric region extends through at least about 50% of the supporting structure but not more than about 85% of the supporting structure.

8. The membrane of claim 1, wherein the hydrophobic polymeric membrane comprises polyvinylidene fluoride.

9. The membrane of claim 1, wherein the hydrophobic polymeric membrane comprises a polymer selected from the group consisting of polysulfone, polyarylsulfone, and polyethersulfone.

10. The membrane of claim 1, wherein the hydrophobic polymeric membrane comprises a polymer selected from the group consisting of polyolefin, polyvinyl chloride, polyacrylonitrile, polytetrafluoroethylene, poly(tetrafluoroethylene-co-ethylene), cellulose, polyester and nylon.

11. The membrane of claim 10, wherein the polyolefin is selected from the group consisting of polyethylene and polypropylene.

12. The membrane of claim 1, wherein a hydrophobic polymer of the hydrophobic polymeric membrane has a surface tension greater than or equal to about 18 dynes/cm.

13. The membrane of claim 12, wherein a hydrophobic polymer of the hydrophobic polymeric membrane has a surface tension greater than or equal to about 25 dynes/cm.

14. The membrane of claim 1, wherein the hydrophilic moiety is selected from the group consisting of hydroxyl groups and carboxylic acid groups.

15. The membrane of claim 1, wherein the hydrophilic moiety is derived from a monomer comprising acrylic acid.

16. The membrane of claim 1, wherein the hydrophilic moiety is derived from a monomer comprising hydroxyethylmethacrylate.

17. The membrane of claim 1, wherein the hydrophilic moiety is derived from a monomer comprising vinylpyrrolidone.

18. A method of preparing a highly asymmetric hydrophilic polymeric membrane, the method comprising the steps of:
providing an asymmetric hydrophobic polymeric membrane comprising a hydrophobic polymer and having a first porous face having a first average pore diameter, a second porous face having a second average pore diameter, and a porous supporting structure therebetween, the first and second average pore diameters having an asymmetry of at least about 2:1;
preparing a monomer solution comprising a solvent and a monomer having a hydrophilic moiety, the monomer being capable of covalently bonding to the hydrophobic polymer;
contacting the membrane with the monomer solution; and
exposing the membrane to an energy source such that the monomer is covalently bonded to the polymer of the membrane by a polymerization reaction.

19. The method of claim 18, wherein the hydrophobic polymer comprises polyvinylidene fluoride.

20. The method of claim 18, wherein the monomer comprises acrylic acid.

21. The method of claim 18, wherein the monomer comprises hydroxyethylmethacrylate.

22. The method of claim 18, wherein the monomer comprises vinylpyrrolidone.

23. The method of claim 18, wherein the solution contains from about 1 to about 30 wt. % monomer.

24. The method of claim 23, wherein the solution contains from about 5 to about 10 wt. % monomer.

25. The method of claim 18, wherein the monomer solution comprises a free radical polymerization initiator and wherein the polymerization reaction is a free radical polymerization reaction.

26. The method of claim 25, wherein the free radical polymerization initiator comprises sodium persulfate.

27. The method of claim 25, wherein the free radical polymerization initiator comprises 2-hydroxy-2-methyl-1-phenyl-1-propan-1-one.

28. The method of claim 25, wherein the solution contains from about 0.05 to about 3 wt. % free radical polymerization initiator.

29. The method of claim 28, wherein the solution contains from about 0.1 to about 1 wt. % free radical polymerization initiator.

30. The method of claim 18, wherein the solvent comprises an alcohol.

31. The method of claim 30, wherein the alcohol is selected from the group consisting of isopropanol, t-amyl alcohol, 1-butanol, 2-butanol, ethanol, and mixtures thereof.

32. The method of claim 18, wherein the solvent comprises a mixture of an alcohol and water.

33. The method of claim 32, wherein the alcohol comprises isopropanol.

34. The method of claim 18, wherein the solvent comprises ethylene glycol.

35. The method of claim 19, further comprising the step of presoaking the membrane in an alkaline solution having a pH of about 9, wherein the presoaking is conducted before the contacting step.

36. The method of claim 35, further comprising the step of rinsing the membrane in a liquid, wherein the step of rinsing the membrane in a liquid is conducted after the step of presoaking the membrane and before the contacting step.

37. The method of claim 36, wherein the liquid comprises water.

38. The method of claim 36, wherein the liquid comprises an alcohol.

39. The method of claim 18, further comprising the step of removing the membrane from the monomer solution, wherein the step is conducted after the contacting step and before the exposing step.

40. The method of claim 18, further comprising the step of rinsing the membrane with a liquid.

41. The method of claim 18, further comprising the step of drying the membrane at an elevated temperature.

42. The method of claim 18, wherein the energy source comprises ultraviolet light.

43. The method of claim 18, wherein the energy source is selected from the group consisting of visible light and thermal radiation.

44. The method of claim 18, wherein the step of exposing the membrane to an energy source comprises exposing the membrane to an ultraviolet radiation on the second porous face.

45. The method of claim 18, wherein the step of exposing the membrane to an energy source is conducted under inert atmosphere.

46. The method of claim 18, wherein the asymmetry between the average pore diameters of the first porous face and the second porous face is at least about 5:1.

47. The method of claim 18, wherein the asymmetry between the average pore diameters of the first porous face and the second porous face is at least about 10:1.

48. The method of claim 18, wherein the asymmetry between the average pore diameters of the first porous face and the second porous face is at least about 20:1.

49. The method of claim 18, wherein the asymmetry between the average pore diameters of the first porous face and the second porous face is at least about 200:1.

50. A method of rendering a hydrophobic polymeric substrate permanently hydrophilic, the method comprising the steps of:
preparing a monomer solution comprising an alkylene glycol solvent, and a monomer having a hydrophilic moiety;
contacting a hydrophobic polymeric substrate with the monomer solution; and
exposing the substrate to an energy source such that the monomer is covalently bonded to the polymer of the substrate by a polymerization reaction.

51. The method of claim 50, wherein the alkylene glycol solvent comprises ethylene glycol.

52. The method of claim 50, wherein the substrate comprises a membrane.

53. The method of claim 52, wherein the substrate comprises an isotropic membrane.

54. The method of claim 52, wherein the substrate comprises an anisotropic membrane.

55. The method of claim 54, wherein the substrate comprises an asymmetric membrane.

56. The method of claim 55, wherein the asy mmetric membrane has a first porous face having a first average pore diameter, a second porous face having a second average pore diameter, and a porous supporting structure therebetween, the first and second average pore diameters having an asymmetry of at least about 2:1.

57. The method of claim 56, wherein the asymmetry between the average pore diameters of the first porous face and the second porous face is at least about 5:1.

58. The method of claim 57, wherein the asymmetry between the average pore diameters of the first porous face and the second porous face is at least about 10:1.

59. The method of claim 58, wherein the asymmetry between the average pore diameters of the first porous face and the second porous face is at least about 20:1.

60. The method of claim 59, wherein the asymmetry between the average pore diameters of the first porous face and the second porous face is at least about 200:1.

61. The method of claim 50, wherein the substrate comprises a melt-blown material.

62. The method of claim 50, wherein the substrate is selected from the group consisting of woven material, nonwoven material, and web.

63. The method of claim 50, wherein the hydrophobic polymer comprises polyvinylidene fluoride.

64. The method of claim 50, wherein the hydrophobic polymer comprises a polymer selected from the group consisting of polysulfone, polyarylsulfone, and polyethersulfone.

65. The method of claim 50, wherein the hydrophobic polymer comprises a polymer selected from the group consisting of polyolefin, polyvinyl chloride, polyacrylonitrile, polytetrafluoroethylene, poly(tetrafluoroethylene-co-ethylene), cellulose, polyester and nylon.

66. The method of claim 50, wherein the solution contains from about 1 to about 30 wt. % monomer.

67. The method of claim 66, wherein the solution contains from about 5 to about 10 wt. % monomer.

68. The method of claim 50, wherein the monomer solution comprises a free radical polymerization initiator and wherein the polymerization reaction is a free radical polymerization reaction.

69. The method of claim 68, wherein the solution contains from about 0.05 to about 3 wt. % free radical polymerization initiator.

70. The method of claim 69, wherein the solution contains from about 0.1 to about 1.0 wt. % free radical polymerization initiator.

71. The method of claim 50, further comprising the step of presoaking the hydrophobic membrane in an alkaline solution having a pH of about 9 or higher to produce a presoaked membrane, wherein the step is conducted before the contacting step.

72. The method of claim 71, further comprising the step of rinsing the presoaked membrane in a liquid, wherein the step is conducted before the contacting step.

73. The method of claim 50, further comprising the step of rinsing the membrane in a liquid.

74. The method of claim 50, further comprising the step of drying the membrane at an elevated temperature.

75. A battery separator comprising an asymmetric hydrophilic polymeric membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure comprise a network of structural surfaces, and wherein the membrane comprises a hydrophobic base polymer and a plurality of hydrophilic moieties covalently bonded to the hydrophobic base polymer at the structural surfaces.

76. The battery separator of claim 75, wherein the asymmetry between the average pore diameters of the first porous face and the second porous face is at least about 5:1.

77. The battery separator of claim 76, wherein the asymmetry between the average pore diameters of the first porous face and the second porous face is at least about 10:1.

78. The battery separator of claim 77, wherein the asymmetry between the average pore diameters of the first porous face and the second porous face is at least about 20:1.

79. The battery separator of claim 78, wherein the asymmetry between the average pore diameters of the first porous face and the second porous face is at least about 200:1.

80. The battery separator of claim 75, wherein the hydrophobic polymer comprises polyvinylidene fluoride.

81. The battery separator of claim 75, wherein the hydrophobic polymer comprises a polymer selected from the group consisting of polysulfone, polyarylsulfone, and polyethersulfone.

82. The battery separator of claim 75, wherein the hydrophobic polymer comprises a polymer selected from the group consisting of polyolefin, polyvinyl chloride, polyacrylonitrile, polytetrafluoroethylene, poly(tetrafluoroethylene-co-ethylene), cellulose, polyester and nylon.
